(19) United States
(12) Patent Application Publication
(10) Pub. No.: US 2006/0010135 A1
(43) Pub. Date: Jan. 12, 2006

(54) Method and apparatus for evaluating document referred to for preparing another document

(75) Inventors: Kosei Takano, Tokyo (JP); Daiji Yamano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/183,973

(22) Filed: Jul. 19, 2005

Related U.S. Application Data
(63) Continuation of application No. PCT/JP03/05624, filed on May 2, 2003.

(51) Int. Cl. G06F 17/30

(52) U.S. Cl. 707/10

(57) ABSTRACT

An apparatus for evaluating a reference document provided to a client device via a network to be referred to for preparing a new document, includes: an acquiring unit that acquires a reference status of the reference document; and an evaluating unit that evaluates, based on the reference status acquired, a contribution level of the reference document.

### BACKGROUND OF THE INVENTION

1. Field of the Invention

The present invention relates to a technology for evaluating a reference document that is utilized for preparing another document.

2. Description of the Related Art

In a conventional document providing system, documents such as a project book or a proposal (deliverables resulting from intellectual/creative activities) prepared in a company are registered in an in-house server, and the registered documents are provided to employees' computers. Moreover, there is a technology for measuring the extent to which such documents are utilized. For example, Japanese Patent Application Laid-Open No. H7-302244 discloses a device that indicates history information indicating which document is provided to which computer.

In business scenes, there are instances where an excellent document is not adopted because of various reasons other than the quality of the document (e.g., a competitor offered a lower price, a competitor has stronger connections with a client, level of the contents is higher than a client's demand). On the other hand, an excellent document that is not adopted for the above reasons can be effectively used as a reference document for preparing a new document. For example, another employee might change the reference document only partially, and use it for another project. The final document is often adopted because the original document is excellent.

In this case, both the employee who prepared the final document and the employee who prepared the original document are entitled to receive a proper evaluation for contributing to the final document. If only the former receives a high evaluation and the latter is left unrecognized, employees are discouraged from making the effort to create superior documents. This can impair the company's growth in the long term.

The conventional technology can indicate which document is provided to which computer, but cannot indicate the extent to which an excellent document contributed as a reference document, and thus cannot give proper evaluation to such document.

### SUMMARY OF THE INVENTION

An apparatus according to an aspect of the present invention, which is an apparatus for evaluating a reference document provided to a client device via a network to be referred to for preparing a new document, includes: an acquiring unit that acquires a reference status of the reference document; and an evaluating unit that evaluates, based on the reference status acquired, a contribution level of the reference document.

A method according to another aspect of the present invention, which is a method for evaluating a reference document provided to a client device via a network to be referred to for preparing a new document, includes: acquiring a reference status of the reference document; and evaluating, based on the reference status acquired, a contribution level of the reference document.

A computer-readable recording medium according to still another aspect of the present invention stores a computer program that causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a document providing system according to an embodiment of the present invention;

FIG. 2 is a block diagram of a document providing server shown in FIG. 1;

FIG. 3 is an example of an order DB shown in FIG. 2;

FIG. 4 is an example of a reference document table shown in FIG. 2;

FIG. 5 is an example of a document DB shown in FIG. 2;

FIG. 6 is a flowchart of an order processing performed by an order processing unit shown in FIG. 2;

FIG. 7 is a flowchart of a reference processing performed by a reference processing unit shown in FIG. 2;

FIG. 8 is a flowchart of a contribution level calculation processing performed by a contribution-level calculating unit shown in FIG. 2;

FIG. 9 is a screen displayed at a client device shown in FIG. 1;

FIG. 10 is another screen displayed at the client device shown in FIG. 1;

FIG. 11A is an example of a usage-status management DB according to another embodiment of the present invention;

FIG. 11B is an example of a usage-type management DB according to another embodiment of the present invention;

FIG. 12 is a diagram of a computer system according to another embodiment of the present invention; and

FIG. 13 is a detailed diagram of the computer system shown in FIG. 12.

### DETAILED DESCRIPTION OF THE PREFERRED EMBODIMENTS

Exemplary embodiments of the present invention will be described below with reference to accompanying drawings. The present invention is not limited to these embodiments.

Key terms used in embodiments of the present invention are described below.

A “document” means a deliverable resulting from intellectual/creative activities in an organization such as a company. Specifically, the “document” corresponds to an electronic file of a project book or a proposal prepared with software such as Word (registered trademark), Excel (registered trademark), PowerPoint (registered trademark), and so forth. In the embodiments, a newly prepared document is called a “new document”, while a document that is used as a reference for preparing the new document is called a “reference document”.

“Operation time” means time taken for preparing a new document. Specifically, the “operation time” corresponds to a time duration from when a user starts operating a computer to prepare the document (input start) to when the document is completed (input save). Moreover, a “normalized operation time Ti” corresponds to the operation time normalized by volume of the document. Specifically, the “normalized operation time Ti” is obtained by dividing the operation time by the number of pages of the document.

“Reference time” means time duration of referring to a reference document. Specifically, the “reference time” corresponds to time duration from when a user opens a reference document in the computer being used to prepare a new document, to when the reference document is closed. Moreover, when a user refers to a plurality of reference documents for preparing a new document, a “reference time ratio Ri” is calculated for each reference document. Specifically, the “reference time ratio Ri” is obtained by dividing the reference time for each reference document by the total reference time for all of the reference documents.

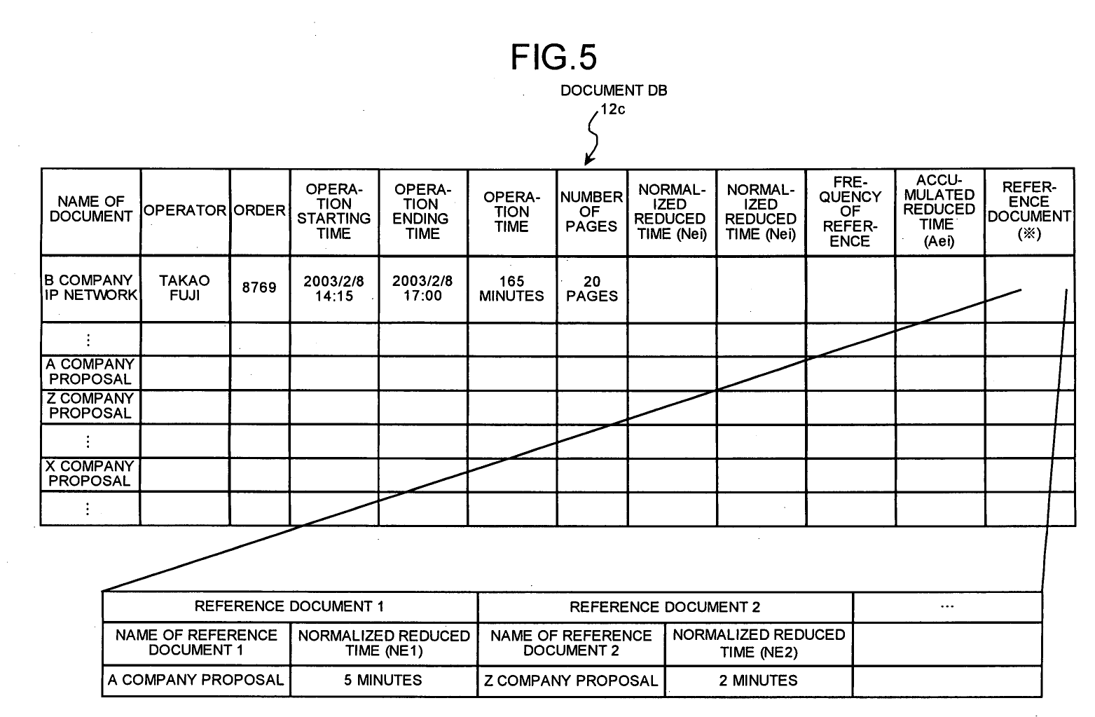

A “normalized reduced time Nei (of a new document)” corresponds to a time that would be included in the “normalized operation time Ti” of a new document if the new document was prepared without referring to any reference document (in other words, corresponds to a time by which the “normalized operation time Ti” of the new document is reduced due to reference to a reference document). Specifically, the “normalized reduced time Nei” is obtained by subtracting a normalized operation time of a new document from a normalized operation time of a reference document (a reference document with the longest reference time, when a plurality of reference documents is referred to for preparing the new document) (see the “normalized reduced time Nei” column of a document DB 12c shown in FIG. 5).

A “normalized reduced time NEi (of a reference document)” is equal to the “normalized reduced time Nei” of a new document if the new document is prepared by referring only to the reference document. On the other hand, when a plurality of reference documents is referred to, the “normalized reduced time NEi (of a reference document)” is obtained by allocating the “normalized reduced time Nei (of a new document)” to each of the reference documents. Specifically, the “normalized reduced time NEi (of a reference document)” is obtained by multiplying the “normalized reduced time Nei (of a new document)” by the “reference time ratio Ri” of each reference document (see the “normalized reduced time NEi” column of the document DB 12c shown in FIG. 5).

An “accumulated reduced time Aei” is obtained by accumulating the operation time reduced by referring to each reference document. Specifically, the “accumulated reduced time Aei” is obtained as follows. When a user refers to a reference document while preparing a new document, the “normalized reduced time NEi (of the reference document)” is multiplied by the number of pages of the new document. The result is sequentially accumulated to the “accumulated reduced time Aei” every time the reference document is referred to (see the “accumulated reduced time Aei” column of the document DB 12c shown in FIG. 5).

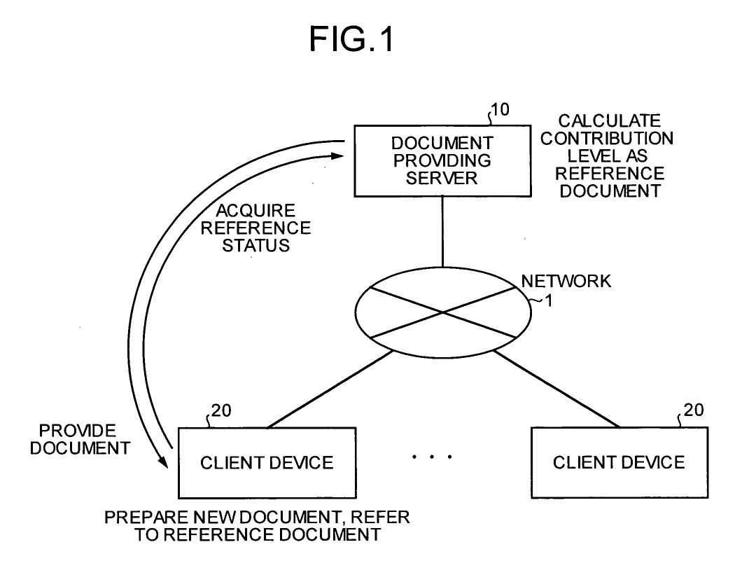

FIG. 1 is a diagram of a document providing system according to an embodiment of the present invention. The document providing system includes a document providing server 10 managed by an organization such as a company, and a plurality of client devices 20 each used by an employee of the organization. The document providing server 10 and the client device 20 are connected and communicate to each other through a network 1, such as the Internet or an internal LAN.

The document providing server 10 manages documents such as project books and proposals prepared by employees as shared property. Moreover, when an employee is preparing a new document at the client device 20, the document providing server 10 provides an appropriate reference document to the client device 20. When the new document is completed, the new document is added to the document providing server 10 as a reference document.

The client device 20 can be any computer used to refer to and prepare documents, such as a personal computer, a work station, a home-use game machine, an Internet TV, a personal digital assistant (PDA), or a mobile communications terminal such as a mobile phone or a personal handyphone system (PHS).

The salient feature of the document providing system is a processing performed by the document providing server 10. Specifically, the document providing server 10 clearly and objectively indicates the extent to which a reference document contributed (contribution level) to prepare a new document. Thus, proper evaluation is given to an excellent reference document that is effectively utilized by a different employee to prepare a new document.

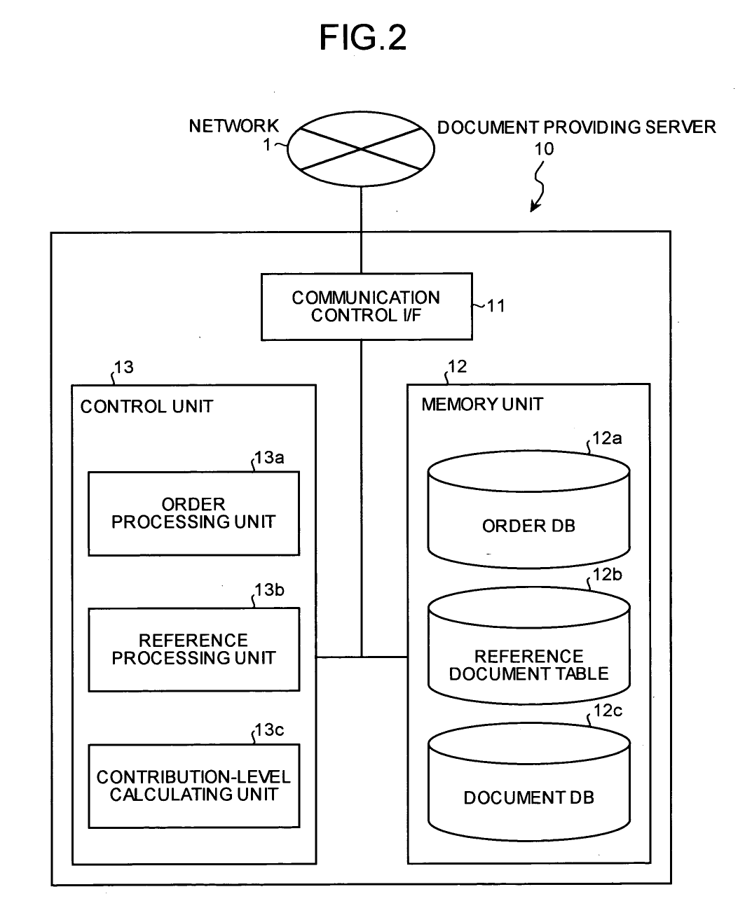

FIG. 2 is a block diagram of the document providing server 10. The document providing server 10 includes a communication control interface (I/F) 11 that controls communication with the client device 20, a memory unit 12, and a control unit 13.

The memory unit 12 stores data (e.g., Web data transmitted to the client device 20) and programs required for various processings performed by the control unit 13. Specifically, the memory unit 12 includes an order DB 12a, a reference document table 12b, and the document DB 12c that are relevant to the present invention.

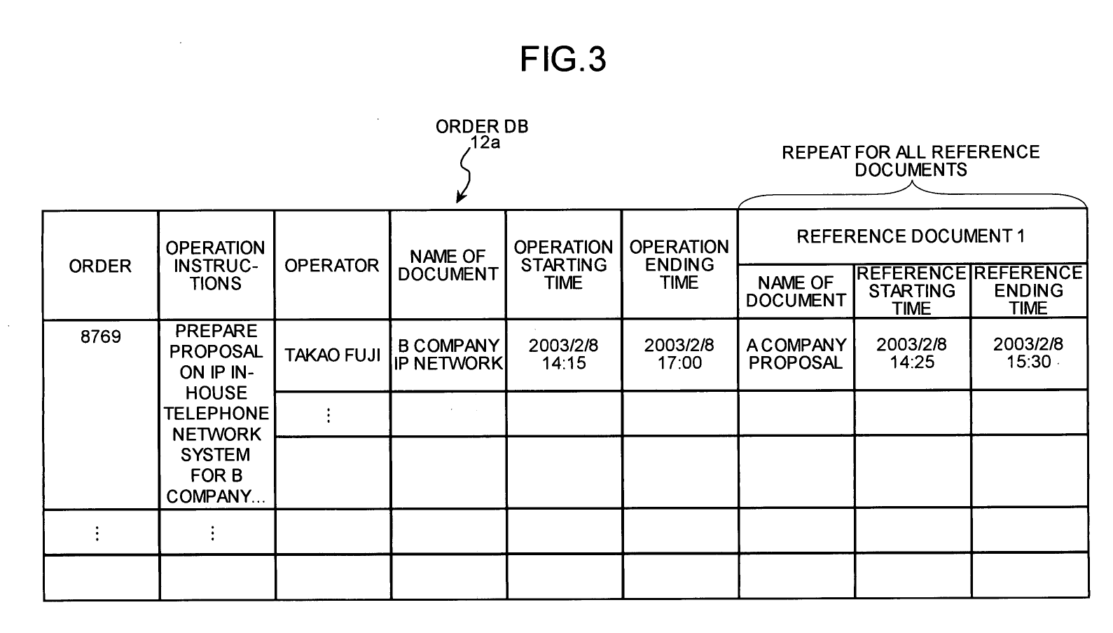

FIG. 3 is an example of the order DB 12a. The order DB 12a stores various data related to an order of an operation being performed by the organization. Specifically, the order DB 12a includes an order number, operation instructions of the order, and a document prepared for the order. The order DB 12a stores for each document, a name of an operator, a document name, an operation starting time, and an operation ending time. Moreover, the order DB 12a stores for each reference document used for preparing a new document, a document name, a reference starting time, and a reference ending time.

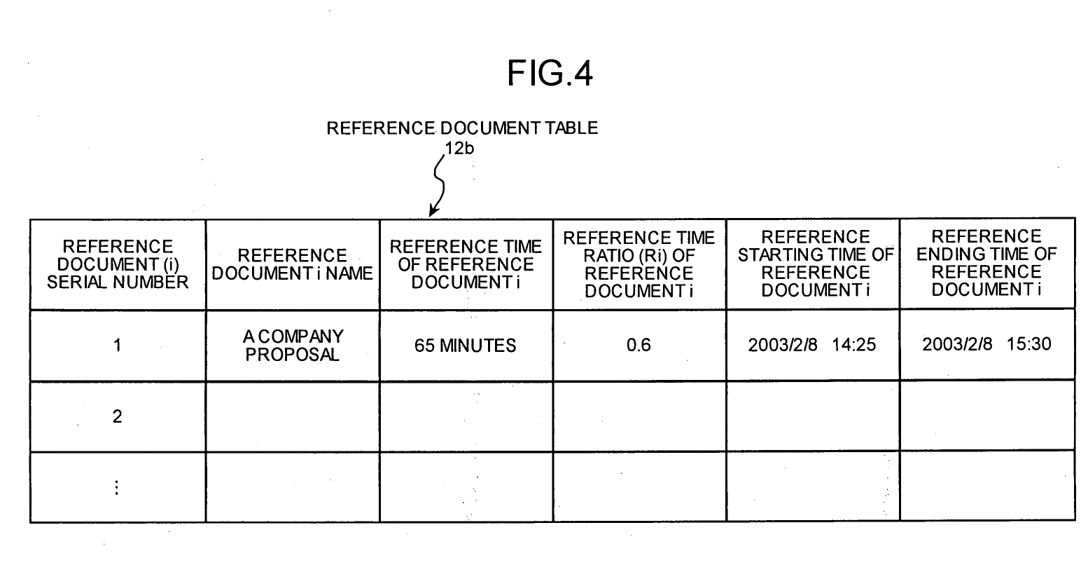

FIG. 4 is an example of the reference document table 12b. The reference document table 12b is a temporary table created for performing a contribution level calculation processing, and includes a plurality of reference documents sorted by length of reference time in a descending order. The reference document table 12b stores for each reference document, a serial number (indicating the order of length of reference time), a document name, a reference time duration, a reference time ratio Ri, a reference starting time, and a reference ending time.

FIG. 5 is an example of the document DB 12c. The document DB 12c stores detailed data of the documents stored in the order DB 12a and the reference document table 12b. The document DB 12c stores for each document, a name of an operator, an order number, an operation starting time, an operation ending time, an operation time duration, number of pages, a normalized operation time Ti, a normalized reduced time Nei, a frequency that the document is used as a reference document, and an accumulated reduced time Aei. Moreover, reference documents used for preparing each document (reference documents sorted in the reference document table 12b) is registered. For each reference document, a document name and a normalized reduced time NEi are registered.

Referring back to FIG. 2, the control unit 13 executes control programs and includes an internal memory. The internal memory stores control programs such as an operating system (OS), programs defining processing procedures (e.g. a program for authenticating an employee), and data required for these programs. Specifically, the control unit 13 includes an order processing unit 13a, a reference processing unit 13b, a contribution-level calculating unit 13c that are relevant to the present invention.

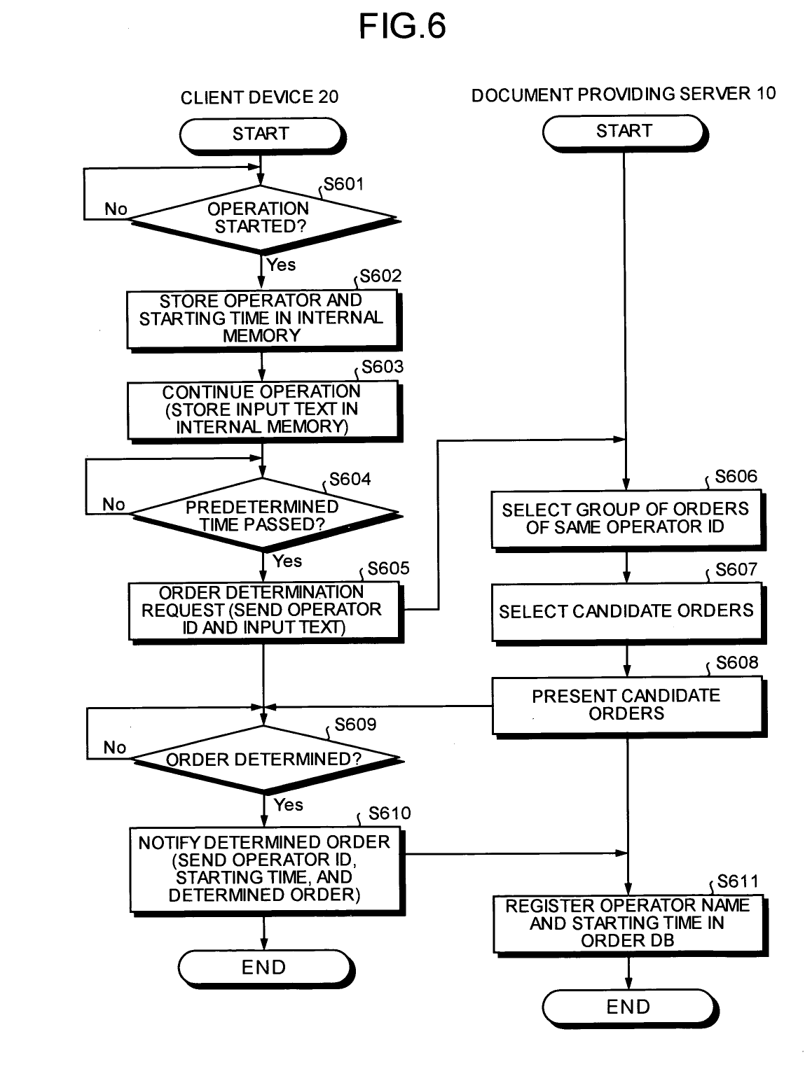

The order processing unit 13a performs processings to register data in the order DB 12a. The reference processing unit 13b performs processings to provide reference documents to the client device 20. The contribution-level calculating unit 13c performs processings to calculate a contribution level of a reference document. Details of these processings are described later with reference to FIGS. 6 to 8.

The document providing server 10 can be implemented by installing the above-described functions in conventional information-processing devices such as a personal computer, a work station, a PDA, or a mobile communications terminal such as a mobile phone or a PHS terminal.

FIG. 6 is a flowchart of an order processing performed by the order processing unit 13a. When an operator of the client device 20 boots a software such as Word, Excel, or PowerPoint and starts operating the client device 20 to prepare a document (Yes at step S601), an operation starting time and a name of the operator (operator ID of the user of the computer) are stored in an internal memory of the client device 20 (step S602).

As the operator continues operating, an input text is stored in the internal memory (step S603). When a predetermined time duration passes from when the operation started (Yes at step S604), the client device 20 sends the input text and the operator ID to the document providing server 10, and makes an “order determination request” to the document providing server 10 (step S605).

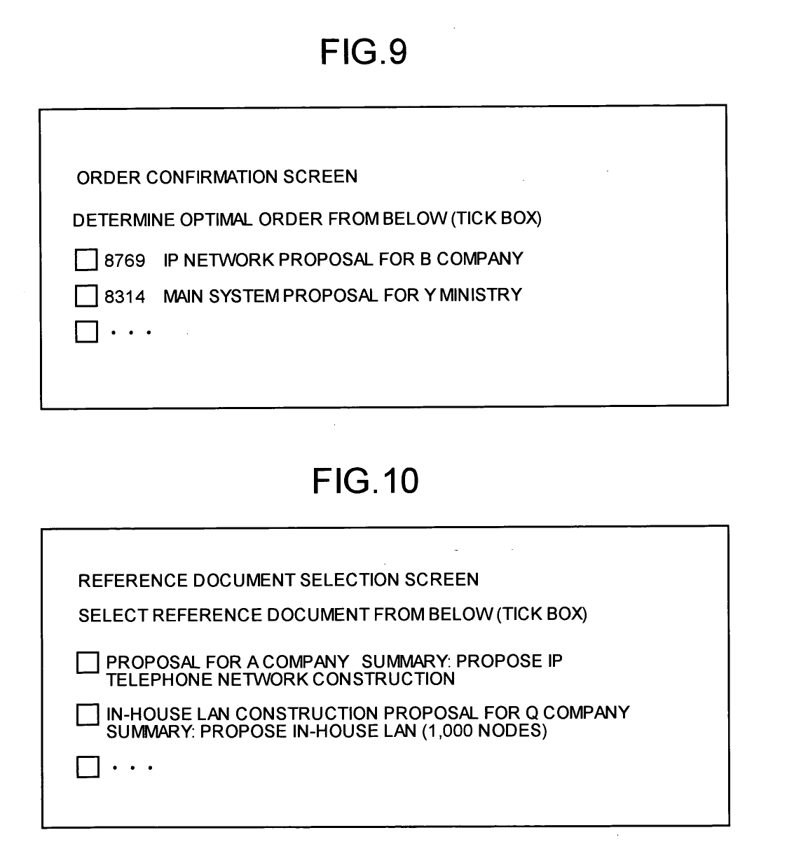

Specifically, the document providing server 10 selects from the order DB 12a a group of orders including the same operator ID as the operator ID received (step S606). The document providing server 10 performs text mining on reference documents of the group of orders and the text received, and selects candidate orders that have contents highly similar to the text received (step S607). The document providing server 10 presents the candidate orders to the operator by sending data of a screen as shown in FIG. 9 to the client device 20, and prompts the operator to determine an order (step S608).

When the operator determines an order at the client device 20 (Yes at step S609), the client device 20 sends to the document providing server 10 the operator name (operator ID), the operation starting time, and an order number of the determined order (step S610). When this information is received, the document providing server 10 registers the operator name and the operation starting time corresponding to the determined order in the order DB 12a (step S611). This processing determines the appropriate order for the document being prepared at the client device 20.

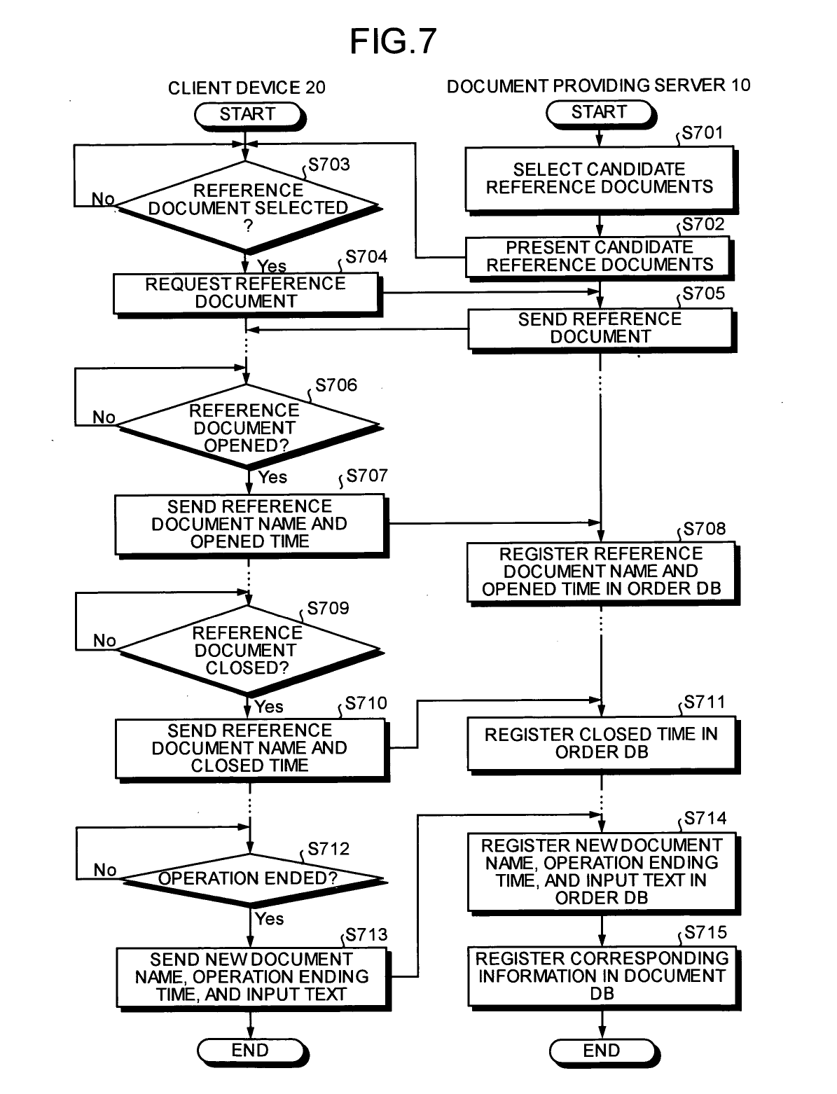

FIG. 7 is a flowchart of a reference processing performed by the reference processing unit 13b. Following the order processing shown in FIG. 6, the document providing server 10 performs text mining on the input text of the new document (for which the order is determined) and the reference documents stored in the order DB 12a. Based on results of the text mining, the document providing server 10 selects candidate reference documents that have contents highly similar to the input text, and sorts the reference documents by the level of similarity in a descending order (step S701).

The document providing server 10 presents the candidate reference documents to the operator by sending data of a screen as shown in FIG. 10 to the client device 20, and prompts the operator to select a reference document (step S702). The screen can include a frequency that each reference document is used as a reference, and an accumulated reduced time Aei stored in the document DB 12c.

When the operator selects a reference document at the client device 20 (Yes at step 703), the client device 20 requests the document providing server 10 to provide (download) the selected reference document (step S704). When the request is received, the document providing server 10 provides the reference document to the client device 20 (step S705). The processing of requesting and providing a reference document (step S703 to step S705) is repeated each time the operator requests a reference document. As a result, a plurality of reference documents is provided to the client device 20.

When a reference document provided from the document providing server 10 is opened at the client device 20 (Yes at step S706), the client device 20 sends the reference document name and the opening time (reference starting time) to the document providing server 10 (step S707). When this information is received, the document providing server 10 registers the reference document name and the opening time in the order DB 12a (step S708). The processing of registering the reference document name and the opening time (step S706 to step S708) is repeated each time a reference document is opened at the client device 20.

When the operator finishes referring to the reference document and closes the reference document at the client device 20 (Yes at step S709), the client device 20 sends the reference document name and the closing time (reference ending time) to the document providing server 10 (step S710). When this information is received, the document providing server 10 registers the closing time in the order DB 12a (step S711). The processing of registering the closing time of the reference document (step S709 to step S711) is repeated each time a reference document is closed at the client device 20.

When the operator ends the operation of preparing the new document (Yes at step S712), the client device 20 sends a new document name, an operation ending time, and the new document itself (the input text) to the document providing server 10 (step S713). When this information is received, the document providing server 10 registers the new document name, the operation ending time, and the input text in the order DB 12a (step S714).

Accordingly, as shown in FIG. 3, the document providing server 10 registers in the order DB 12a the operator, the new document name, the operation starting time, and the operation ending time for the new document, and the reference document name, the reference starting time, and the reference ending time for the reference document used for preparing the new document. Subsequently, the document providing server 10 registers corresponding information in the document DB 12c (step S715). Specifically, the document providing server 10 registers in the document DB 12c, the operator, the order number, the operation starting time, the operation ending time, an operation time, a number of pages, and a normalized operation time Ti (operation time divided by number of pages).

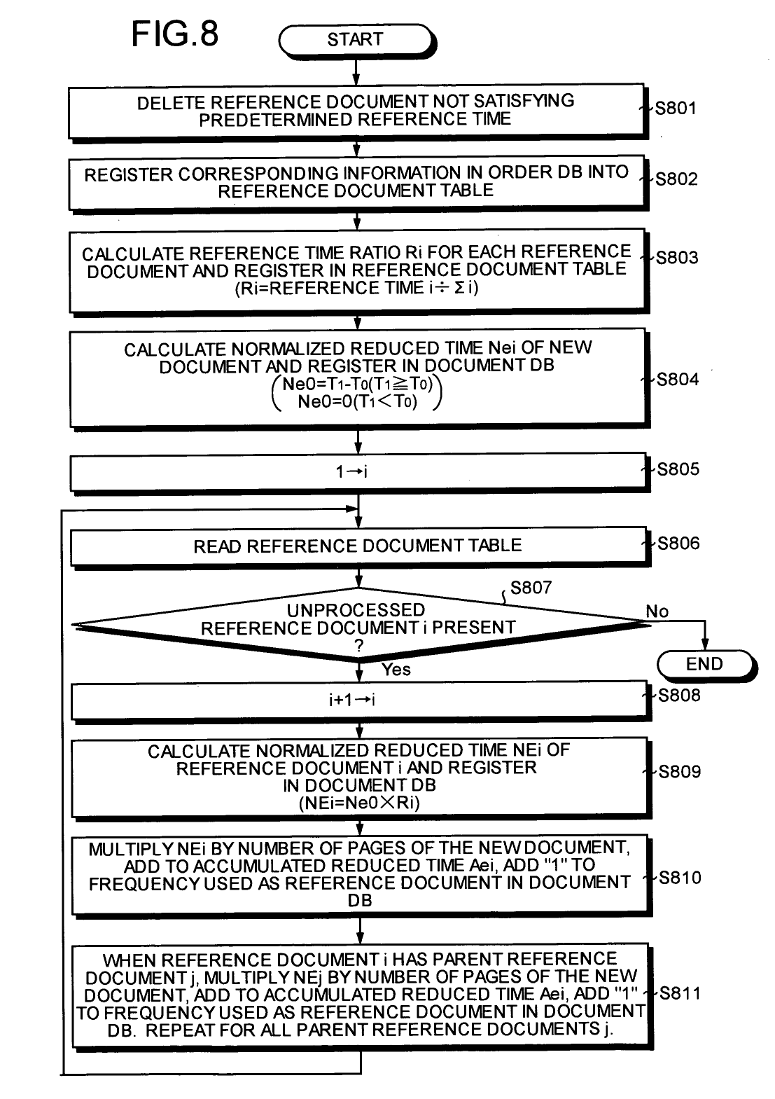

FIG. 8 is a flowchart of a contribution level calculation processing performed by the contribution-level calculating unit 13c. Specifically, an accumulated reduced time Aei and a normalized reduced time NEi are calculated to evaluate how much a reference document contributed (contribution level) to prepare a new document.

Following the processings shown in FIGS. 6 and 7, the document providing server 10 updates the order DB 12a by deleting a reference document not satisfying a predetermined reference time (step S801). If a reference time of a reference document does not reach a predetermined reference time, it is considered that the reference document does not contribute to the new document, and is thus eliminated.

For each of the remaining reference documents, the document providing server 10 registers corresponding information in the order DB 12a into the reference document table 12b (step S802). Specifically, the document providing server 10 sorts the reference documents by length of reference time in a descending order, and registers for each reference document, a serial number (indicating the order of length of reference time), a document name, a reference time duration, a reference starting time, and a reference ending time in the reference document table 12b. Moreover, the document providing server 10 calculates a reference time ratio Ri for each reference document and registers it in the reference document table 12b (step S803). The reference time ratio Ri is obtained by dividing the reference time of each reference document by the total reference time of all reference documents.

The document providing server 10 calculates a normalized reduced time Nei of the new document, and registers the calculated time in the document DB 12c (step S804). The normalized reduced time Nei of the new document is obtained by subtracting the normalized operation time Nei of the new document from the normalized operation time of a reference document (when there is a plurality of reference documents, the reference document with the longest reference time listed at the top of the reference document table 12b). The document providing server 10 then calculates contribution levels of each reference document.

The document providing server 10 initializes object data (step S805), reads the data in the reference document table 12b (step S806), and checks whether there is an unprocessed reference document i (i.e., reference documents for which the contribution level is not calculated) (step S807). When there are no unprocessed reference document i in the reference document table 12b (No at step S807), the processing ends. When there is an unprocessed reference document i in the reference document table 12b (Yes at step S807), it becomes the object of contribution level calculation processing (step S808).

The document providing server 10 calculates the normalized reduced time NEi of the reference document i, and registers the calculated time corresponding to the reference document used for the new document in the document DB 12c (step S809). The normalized reduced time NEi of the reference document i obtained by multiplying the normalized reduced time Nei of the new document by the reference time ratio Ri of the reference document i is registered corresponding to the reference document (e.g., for the reference document called “A company proposal”) in the document DB 12c.

The document providing server 10 multiplies the normalized reduced time NEi of the reference document i by the number of pages of the new document, adds the result to the accumulated reduced time Aei, and adds “1” to the frequency used as a reference document, corresponding to the reference document i in the document DB 12c (step S810). In the example shown in FIG. 5, the document providing server 10 multiplies the normalized reduced time NE1 of “A company proposal” that is the reference document for “B company IP network” by the number pages of the “B company IP network”, and adds the result to the accumulated reduced time Aei corresponding to the “A company proposal”.

If the reference document i was prepared by referring to another reference document j (parent document), the document providing server 10 accumulates the accumulated reduced time Aei and adds “1” to the frequency used as a reference document for the reference document j. The same processing is repeated for all parent reference documents j (step S811). In the example shown in FIG. 5, if the “A company proposal” is prepared by referring to the “X company proposal”, the document providing server 10 multiplies the normalized reduced time NEi of “X company proposal” by the number pages of the “A company proposal”, and adds the result to the accumulated reduced time Aei corresponding to the “X company proposal”.

By repeating the processings of steps S806 to S811, the accumulated reduced time Aei and the frequency used as a reference document are accumulated for each reference document used for preparing a new document. If there is a parent reference document used for preparing a reference document, the accumulated reduced time Aei and the frequency used as a reference document are accumulated for all of the parent reference documents. Accordingly, the document providing server 10 can clearly and objectively indicate contribution levels of reference documents with the accumulated reduced time Aei and the frequency used as a reference document. Thus, proper evaluation is given to an excellent reference document that is effectively utilized to prepare a new document.

The present invention is not limited to the embodiments described above. Various changes may be made without departing from the scope of the present invention. Various changes are described for each of the following features.

For example, in the above embodiments, the document providing server 10 acquires reference time (opening time and closing time) as a reference status. However, the document providing server 10 can acquire any data that can be used for calculating a contribution level. Examples of such data include a record of a text copied from a reference document and pasted to a new document (range of text pasted and a frequency of pasting), a printing record (range of text printed and a frequency of printing), a displaying record (frequency that a reference document is displayed partially or full-screen), at the client device 20.

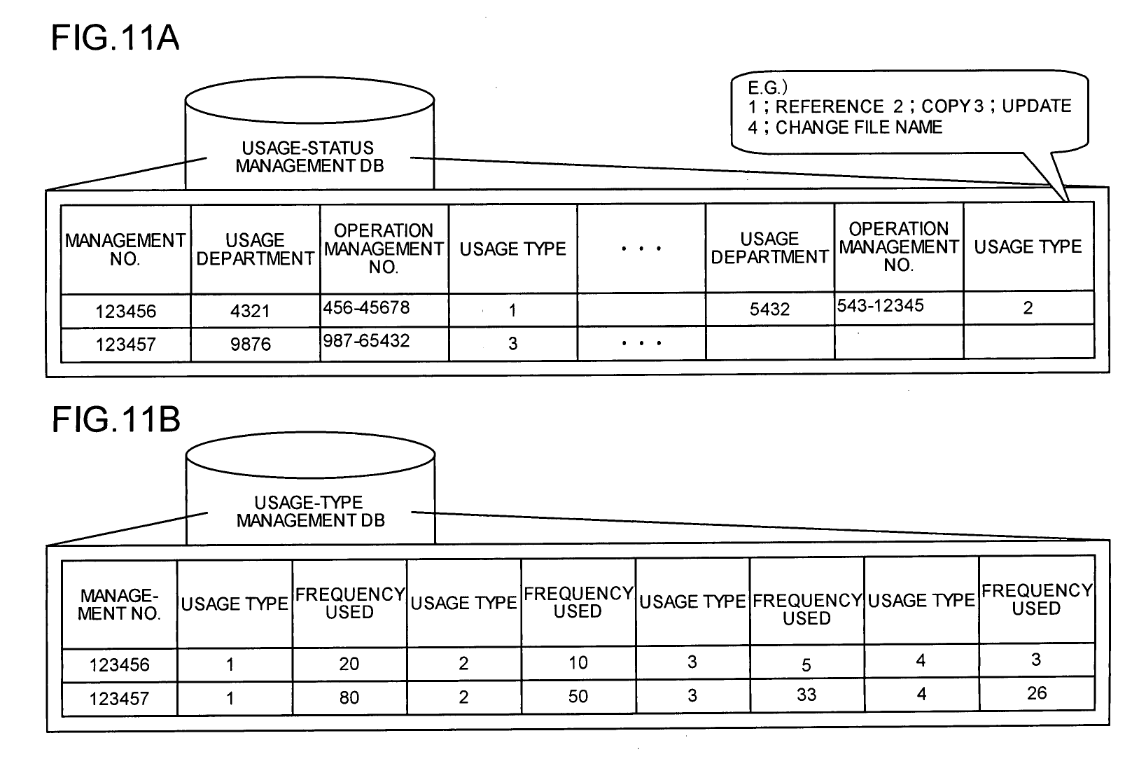

FIG. 11A is an example of a usage-status management DB. Data on usage type is registered and managed in the usage-status management DB. Such data shows how a reference document is used, e.g., reference, copy, update, or change of file name. FIG. 11B is an example of a usage-type management DB. The usage-type management DB compiles the data shown in FIG. 11A for each reference document. The compiled data can be used to calculate contribution levels.

In the above embodiments, a reduced operation time is calculated from a reference time to indicate a contribution level. However, the reference time itself can be used as a contribution level. In other words, the document providing server 10 can clearly and objectively indicate that the longer the reference time, the higher the contribution level. Thus, proper evaluation is given to an excellent reference document used for long time duration.

In the above embodiments, a normalized reduced time Nei of a new document is obtained by subtracting a normalized operation time of the new document from a normalized operation time of a reference document. However, other methods can be used to calculate a normalized reduced time Nei of a new document (such as subtracting a normalized operation time of the new document from an average operation time of the same operator or the same order).

In the above embodiments, when a plurality of reference documents is used to prepare a new document, a contribution level is allocated to each reference document according to the reference time (i.e., according to the reference time ratio Ri). However, the contribution level can be allocated according to a frequency that each reference document is referred to or volume (number of pages) of each reference document.

In the above embodiments, a cumulative of NEi×Ri is calculated as a contribution level. However, the contribution level can be weighted appropriately. Specifically, a level of similarity between a reference document and a new document can be taken into consideration. The higher the similarity level, the more the reference document is utilized effectively. Thus, weight of a contribution level can be adjusted according to the similarity level, so that a precise contribution level is obtained.

Moreover, a contribution level can be weighted (adjusted) according to a record of texts pasted from a reference document to a new document at the client device 20 (amount of the pasted data, frequency of paste, etc.). The more a reference document is pasted to a new document, the more the reference document is utilized effectively. Likewise, a contribution level can be weighted (adjusted) according to the printing record (amount of the pasted data, frequency of printing, etc.), the displaying record (whether being displayed as the top window, full-size window, etc.) and the frequency being provided as a reference document. Thus, a precise contribution level is indicated.

All the automatic processes explained in the embodiments can be, entirely or in part, carried out manually. Similarly, all the manual processes explained in the embodiments can be entirely or in part carried out automatically by a known method. The sequence of processes, the sequence of controls, specific names, and data including various parameters can be changed as required unless otherwise specified.

The constituent elements of the document providing server 10 illustrated are merely conceptual and may not necessarily physically resemble the structures shown in the drawings. For instance, the document providing server 10 need not necessarily have the structure that is illustrated. The document providing server 10 as a whole or in parts can be broken down or integrated either functionally or physically in accordance with the load or how the device is to be used. The process functions performed by the document providing server 10 are entirely or partially realized by a CPU or a program executed by the CPU or by a hardware using wired logic.

The processings according to the embodiments of the present invention can be implemented on a computer system such as a personal computer or a work station by executing a computer program.

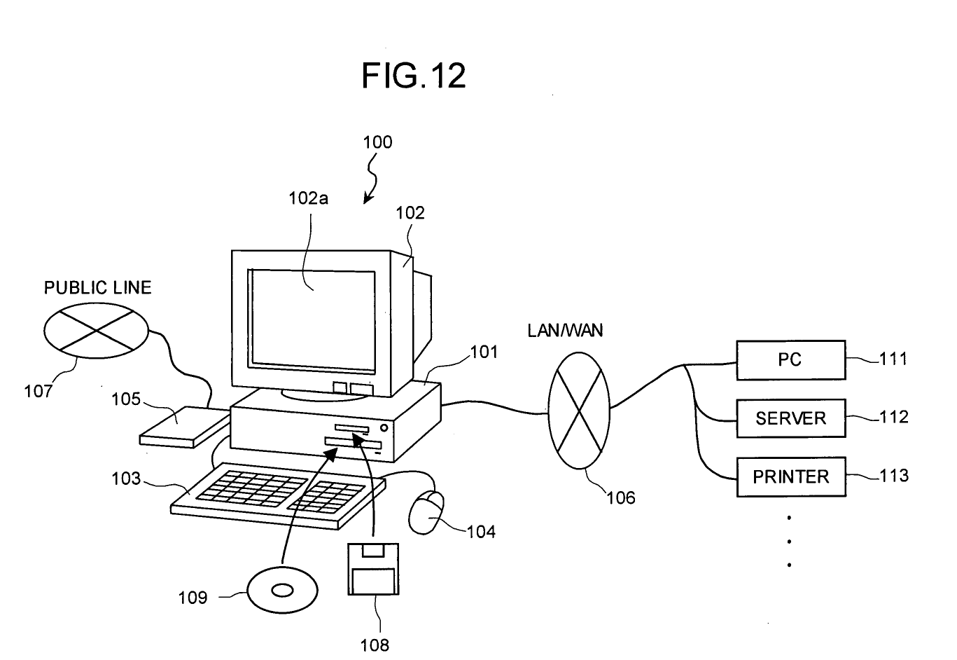

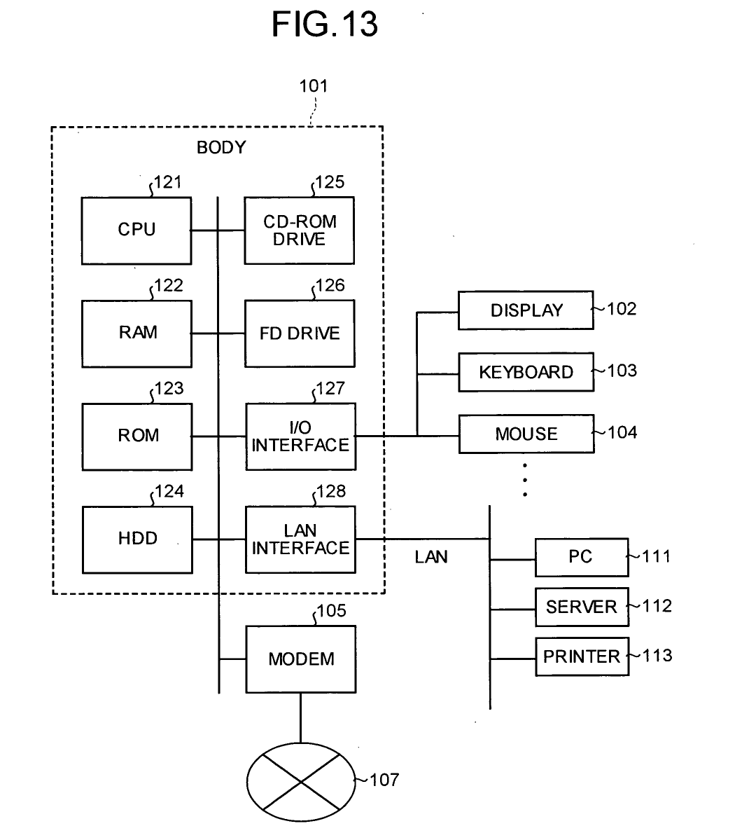

FIG. 12 is a diagram of a computer system 100 according to the present invention, and FIG. 13 is a detailed diagram of the computer system 100.

The computer system 100 includes the body 101, a display 102 that displays data on a screen 102a in response to an instruction from the body 101, a keyboard 103 used to input data in the computer system 100, and a mouse 104 that specifies a position on the screen 102a.

The body 101 includes a CPU 121, a RAM 122, a ROM 123, a hard disk drive (HDD) 124, a CD-ROM drive 125 for loading a CD-ROM 109, a flexible disk (FD) drive 126 for loading an FD 108, an I/O interface 127 that connects the body 101 to the display 102, the keyboard 103, and the mouse 104, and a LAN interface 128 that connects the body 101 to a local area network or a wide area network (LAN/WAN) 106.

Furthermore, the computer system 100 includes a modem 105 for connecting the body 101 to a public line 107 such as the Internet. The LAN/WAN 106 connects the computer system 100 to another computer system (PC) 111, a server 112, a printer 113, and so forth.

The same functions as the above embodiments can be implemented by executing a program stored in any recording medium that is readable by the computer system 100. The program can be stored in transportable storage media such as the FD 108, the CD-ROM 109, an MO disk, a DVD disk, a magnet-optical disk, and an IC card. The program can be stored in fixed storage media such as the HDD 124, the RAM 122 or the ROM 123, provided inside or outside the computer system 100. The program can be stored in communication media such as a database in another computer system 111 or the server 112 connected through the LAN/WAN 106, or in a database connected through the public line 107, and so forth.

Moreover, instead of being executed by the computer system 100, the program can be executed by another computer system 111 or the server 112, either independently or in collaboration.

The present invention is able to clearly and objectively indicate how much a reference document contributed (contribution level) to prepare a new document. Thus, proper evaluation is given to an excellent reference document that is effectively utilized by a different employee to prepare a new document. In other words, even when an excellent document such as a project book or a proposal is not evaluated properly, the employee who prepared the document can receive a high evaluation. Accordingly, an employee with superior skills in preparing documents is not left unrecognized. Moreover, in the long view, a company can encourage employees to create and utilize valuable documents (intellectual property).

The present invention is able to clearly and objectively indicate that the longer the reference time, the higher the contribution level. Thus, proper evaluation is given to an excellent reference document used for long time duration.

The present invention is able to clearly and objectively indicate that the longer the reduced operation time of a new document is by referring to a reference document, the higher the contribution level of the reference document. Thus, proper evaluation is given to an excellent reference document that significantly reduces operation time taken for preparing a new document.

The higher a similarity level between a reference document and a new document, the more the reference document is utilized effectively. The present invention is able to weight (adjust) a contribution level according to the similarity level, so that a precise contribution level is indicated.

The more a text of a reference document is copied and pasted to a new document, the more the reference document is utilized effectively. The present invention is able to weight (adjust) a contribution level according to the pasting record, so that a precise contribution level is indicated.

The more a text of a reference document is printed out, the more the reference document is utilized effectively. The present invention is able to weight (adjust) a contribution level according to the printing record, so that a precise contribution level is indicated.

The more a reference document is displayed on a screen, the more the reference document is utilized effectively. The present invention is able to weight (adjust) a contribution level according to the displaying record, so that a precise contribution level is indicated.

The more frequently a reference document is referred to, the more the reference document is utilized effectively. The present invention is able to weight (adjust) a contribution level according to the frequency used as a reference document, so that a precise contribution level is indicated.

The present invention is able to indicate an actual contribution level of a document, regardless of volume.

Even when a plurality of reference documents is used, the present invention is able to indicate separate contribution levels for each reference document.

The present invention is able to give proper evaluation not only to a reference document used directly for preparing a new document, but also to a parent reference document used for preparing the reference document.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for evaluating a reference document provided to a client device via a network to be referred to for preparing a new document, the apparatus comprising:
an acquiring unit that acquires a reference status of the reference document; and
an evaluating unit that evaluates, based on the reference status acquired, a contribution level of the reference document.

2. The apparatus according to claim 1, wherein
the reference status includes a reference time for which the reference document is referred to at the client device, and
the evaluating unit evaluates the contribution level based on the reference time.

3. The apparatus according to claim 2, wherein the evaluating unit evaluates the contribution level by calculating a reduced time in preparing the new document by referring to the reference document, based on the reference time and a time taken for preparing the new document at the client device.

4. The apparatus according to claim 3, wherein the evaluating unit evaluates, when a plurality of reference documents are provided to the client device, the contribution level of each of the reference documents by distributing the reduced time to each of the reference documents based on at least one of a reference time for which each of the reference documents is referred to at the client device, a frequency at which each of the reference documents is referred to at the client device, and a volume of each of the reference documents.

5. The apparatus according to claim 1, wherein the contribution level is normalized with a volume of the reference document and a volume of the new document.

6. The apparatus according to claim 1, further comprising an adjusting unit that adjusts the contribution level evaluated according to a similarity level between the reference document and the new document.

7. The apparatus according to claim 1, further comprising an adjusting unit that adjusts the contribution level evaluated according to a record of copying and pasting contents of the reference document from the reference document to the new document.

8. The apparatus according to claim 1, further comprising an adjusting unit that adjusts the contribution level evaluated according to a record of printing contents of the reference document performed by the client device.

9. The apparatus according to claim 1, further comprising an adjusting unit that adjusts the contribution level evaluated according to a record of displaying contents of the reference document on a display of the client device.

10. The apparatus according to claim 1, further comprising an adjusting unit that adjusts the contribution level evaluated according to a frequency at which the reference document is referred to at the client device.

11. The apparatus according to claim 1, wherein the evaluating unit evaluates, when the reference document is prepared by referring to a parent document, the contribution level of the parent document.

12. A method for evaluating a reference document provided to a client device via a network to be referred to for preparing a new document, the method comprising:
acquiring a reference status of the reference document; and
evaluating, based on the reference status acquired, a contribution level of the reference document.

13. A computer-readable recording medium that stores a computer program for evaluating a reference document provided to a client device via a network to be referred to for preparing a new document, wherein the computer program causes a computer to execute:
acquiring a reference status of the reference document; and
evaluating, based on the reference status acquired, a contribution level of the reference document.
